(19) United States
(12) Patent Application Publication
(10) Pub. No.: US 2016/0175734 A1
(43) Pub. Date: Jun. 23, 2016

(54) DISTRIBUTOR TRAY FOR HEAT AND/OR MATERIAL EXCHANGE COLUMNCOMPRISING BUBBLING MEANS

(71) Applicant: IFP Energies nouvelles, RUEIL-MALMASION CEDEX (FR)

(72) Inventors: Yacine HAROUN, Davis, CA (US); Aude ROYON-LEBEAUD, LYON (FR); Ludovic RAYNAL, OUILLINS (FR)

(21) Appl. No.: 14/976,805

(22) Filed: Dec. 21, 2015

(30) Foreign Application Priority Data
Dec. 19, 2014 (FR) 14/62.948

(51) Int. Cl. B01D 3/32; B01F 3/04; B01D 53/18

(52) U.S. Cl. CPC B01D 3/324; B01D 53/185; B01F 3/04078; B01F 3/0412; B01F 3/04468; B01F 2003/04198

(57) ABSTRACT

The invention relates to a collector/distributor/exchanger tray 2 of a column for heating and/or material exchange between a gas and a liquid, comprising liquid passage means 14 and gas passage casings 4 to which gas bubbling means 15 are attached. The bubbling means allow an emulsion zone to be created in the upper part of distributor/exchanger tray 2. The invention also relates to an exchange column comprising the distributor tray and to the use of the same.

### CROSS REFERENCE TO RELATED APPLICATION

Reference is made to French Patent Application No. 14/62.948 which is incorporated herein by reference in its entirety.

### BACKGROUND OF THE INVENTION

1. Field of the Invention

The present invention relates to gas/liquid contact columns, and more particularly to columns for gas treatment, CO₂ capture, dehydration or distillation units.

2. Description of the Prior Art

Gas treatment and/or CO₂ capture units using amine wash processes and/or distillation and/or dehydration units comprise columns for material and/or heat exchange between a gas and a liquid which can be for example liquid or gaseous fluid absorption and regeneration columns. These columns operate under counter-current or co-current gas/liquid flow conditions.

The columns used in these gas treatment and/or CO₂ capture and/or distillation and/or dehydration units generally operate on the principle of material and/or heat exchange between the gas and the fluid that circulates in the columns. FIG. 1 shows a particular case of a gas treatment column top 1 equipped with a distributor tray 2. Conventionally, this gas treatment column 1 comprises sections 3 filled by a contactor with a distributor tray 2 arranged above each section 3. The gas/liquid contactor contacts gas G with liquid L to allow exchanges.

For example, standard distributors 2 used in absorption/regeneration or distillation columns generally have a collector/distributor tray equipped with casings 4 (also referred to as chimneys) for passage of the gas through the tray (see FIG. 2). Distribution of the liquid occurs when passage thereof through orifices 5 provided in the lower part of tray 2 and distribution of the gas occurs through casings 4. Each casing 4 allows passage of the gas, according to the counter-current or co-current operating mode, from the lower part of the column to the upper part of column 1, or from the upper part to the lower part. Casings 4 project from one side of tray 2 which are perpendicular thereto. Each casing 4 has walls which are parallelepipedic or cylindrical for example. The Walls define an inner volume that is open on either side of tray 2. In order to prevent the liquid from flowing into casings 4, the gas outlet or inlet opening above the tray (depending on the counter-current or co-current mode) is preferably covered by a cap (also referred to as bevel). The purpose of the distributor tray is to distribute liquid L homogeneously over gas/liquid contactor 3.

In order to optimize exchanges between gas and liquid, many distributor trays have been developed. These distributor/collector trays can be classified into two main families which are:

Distributor/collector systems having chimneys, as described in GB-1,169,878A, U.S. Pat. Nos. 4,808,350, 4,472,325, 4,427,605, and 4,839,108, and in French Patent 2,203,659. For this type of system with chimneys, the liquid is distributed via orifices provided on the tray or via liquid passage chimneys equipped with orifices or slots (see example of FIG. 2), and the gas is distributed through gas passage chimneys or casings;

Systems with distributor casings supplied through a dedicated feed system (upstream collecting system or intermediate feed), as described in U.S. Pat. Nos. 4,909,967, 4,816,191, and 4,981,265, DE-2,752,391, WO-8,802,647, French Patent 2,569,129, or distributor/collector systems with gas passage casings as described in U.S. Pat. Nos. 4,689,183, 5,132,055, and 4,432,913.

However, these liquid distribution systems do not contribute to material and/or heat exchanges in the column and these liquid distributions represent a part of the column where no exchange between fluids occurs. Thus, these distribution systems represent “height losses” regarding the column efficiency.

Furthermore, contactors of the exchange tray type are known in the prior art. These trays allow heat and material exchange between fluids and they are placed on top of each other in a column without any contactor between the trays. These trays have no distribution purpose.

FIG. 3 describes the operating mode of a usual exchange tray.

The liquid flows from an upper tray 7a to a lower tray 7b by passing through an upper downcomer 6, then along the exchange zone on tray 7b, prior to flowing over dam 8 towards lower downcomer 9. The gas coming from lower tray 10 flows in a counter-current flow in the column through valves or perforations (not shown) provided on tray 7b. The gas forms bubbles on exchange zone 6 and disengages from the liquid in zones 12 and 13 prior to reaching upper tray 7a. The downcomers of the exchange contactor trays are conventionally arranged on the periphery of the tray in the case of single-pass trays, but they can be positioned on central sections for multipass trays depending on the diameter of the column.

There are many tray contactor variants. A first type is the valve tray is described in WO-9,924,135A1, CA-1,253,432A and U.S. Pat. No. 3,399,871. A second type is the perforated tray as illustrated in U.S. Pat. Nos. 4,504,426 and 5,213,719.

However, such an exchange tray does not ensure good delivery and good distribution of the liquid, notably for supplying a contactor (packing). Such trays cannot be used as distributor trays.

### SUMMARY OF THE INVENTION

The invention relates to a collector/distributor/exchanger tray of a column for material and/or heat exchange between a gas and a liquid, comprising liquid passage means and gas passage casings to which gas bubbling means are attached. The bubbling means has an emulsion zone which is created in the upper part of the distributor/exchanger tray. Thus, the distributor/exchanger tray according to the invention allows obtaining an increase in material and/or heat exchanges between the fluids while ensuring good distribution of the liquid.

The invention relates to a distributor tray for a column for heat and/or material exchange between a gas and a liquid, comprising at least one casing projecting from the upper part of the tray for passage of the gas through the tray and at least one means for passage of the liquid through the tray. The casing comprises at least one bubbling means for the gas.

According to the invention, the casing is substantially parallelepipedic in shape.

According to one aspect of the invention, the bubbling means comprises at least one valve and/or one slot in the casing.

Advantageously, the slot is substantially rectangular in shape.

According to a variant of the invention, the longitudinal direction of the slot is substantially perpendicular to the longitudinal direction of the casing.

Alternatively, the longitudinal direction of the slot is substantially parallel to the longitudinal direction of the casing.

According to an embodiment, the slot is covered by a cap.

According to a feature of the invention, the valve is substantially rectangular.

According to an alternative, the valve is substantially cylindrical.

Preferably, the liquid passage means comprises a plurality of orifices and/or chimneys.

Advantageously, the chimneys project from the upper part of the tray and/or the lower part of the tray.

According to an aspect of the invention, the tray comprises a plurality of liquid passage means evenly distributed over the tray.

Furthermore, the invention relates to a column producing heat and/or material exchange between a gas and a liquid, wherein the two fluids are contacted by a packing. The column comprises at least one distributor tray according to the invention, allowing distribution of the fluids over the packing.

The invention also relates to the use of a column according to the invention for a gas treatment, CO₂ capture, distillation, dehydration or an air conversion process.

### BRIEF DESCRIPTION OF THE DRAWINGS

Other features and advantages of the device according to the invention will be clear from reading the description hereafter of embodiments given by way of non limitative example, with reference to the accompanying figures wherein:

FIG. 1, already described, illustrates the particular case of a gas treatment or CO₂ capture column top equipped with a distributor tray;

FIG. 2, already described, illustrates a distributor tray according to the prior art

FIG. 3, already described, illustrates a tray type contactor according to the prior art;

FIG. 4 illustrates a distributor tray according to an embodiment of the invention; and

FIGS. 5a to 5e show a portion of a distributor tray according to several variant embodiments of the invention.

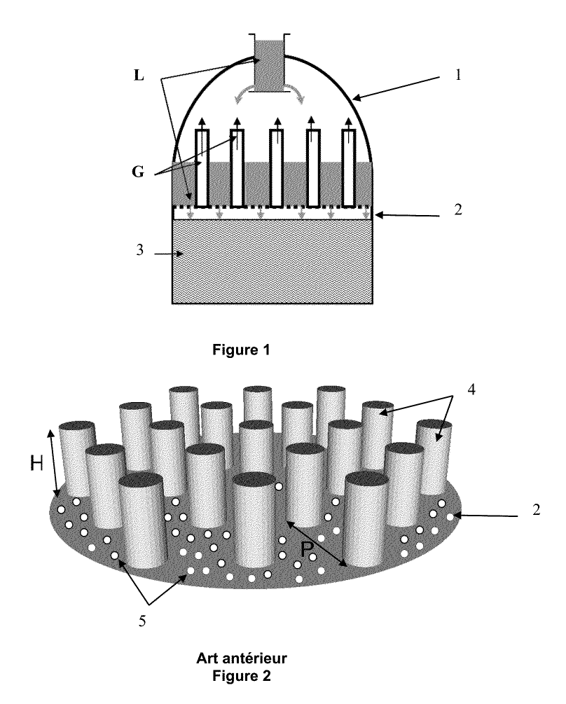

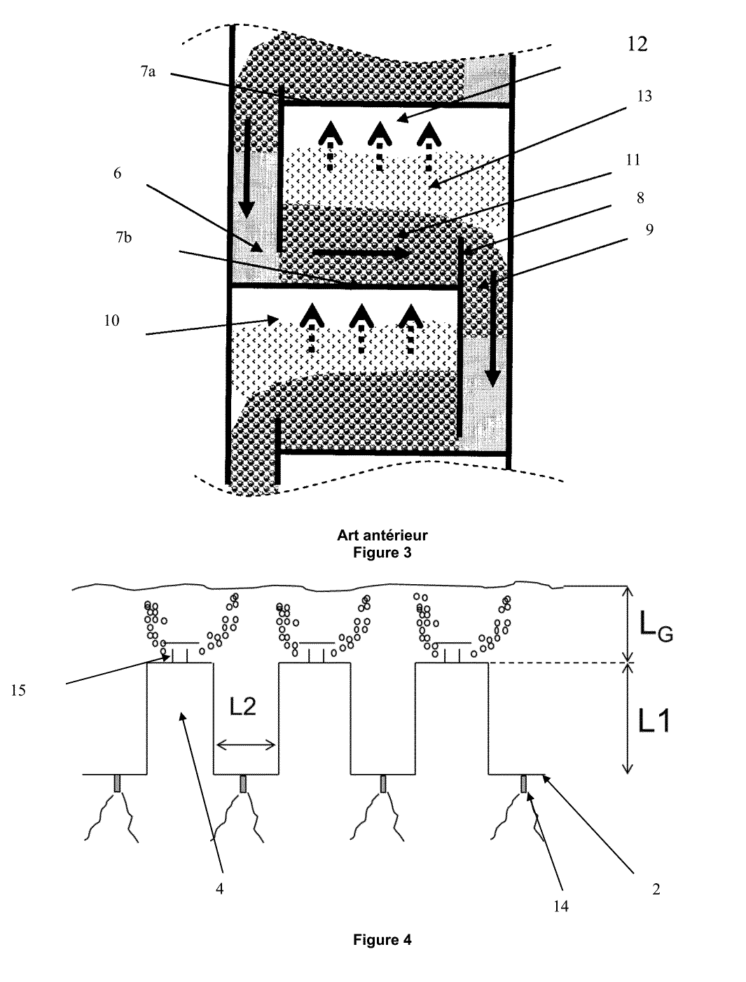

### DETAILED DESCRIPTION OF THE INVENTION

The present invention relates to a distributor tray for a column for producing heat and/or material exchange between a gas and a liquid, comprising at least one means providing passage of the gas through the tray, such as a casing projecting from the upper part of the tray, and at least one means allowing passage of the liquid through the tray. The distributor tray forms a liquid guard on the upper surface thereof, that is, a height of liquid on the upper face of the tray. The casings project from the upper part of the tray to be oriented towards the top of the column. The distributor tray according to the invention is suited for counter-current flows in the heat and/or material exchange column with the gas flowing upwards through the casings and the liquid flowing downwards through the chimneys and the distribution means. Conventionally, the distributor/exchanger tray is substantially cylindrical.

According to the invention, at least one casing comprises means for bubbling gas. Advantageously, all the casings comprise means for bubbling gas to increase heat and/or material exchanges between the fluids. Alternatively, only some casings comprise gas bubbling means to optimize the exchange/congestion compromise. A gas bubbling means allows, when it is traversed by the gas, to form gas bubbles in the liquid guard on the upper surface of the tray, which generates an emulsion zone where the material and/or heat transfer between the liquid and the gas in bubble form can occur. Thus, the useful height of the tray also contributes to the heat and/or material exchange, in addition to the exchanges carried out in the contactor. The distribution system therefore represents no “loss of height” regarding the column efficiency. A column containing such a distributor tray can thus be of reduced height, which allows the cost of the column to be decreased.

Preferably, the gas bubbling means are positioned in the upper part of the casings, notably on the horizontal upper wall of the casings. The gas bubbling means can comprise a valve whose opening generates gas bubbles. Opening of the valve is initiated by the gas pressure. The valve can comprise a part rotatably mobile around an axis. Alternatively, the valve can comprise a part in vertical translation with respect to the tray. According to another embodiment, the gas bubbling means can comprise slots in the casing. Alternatively, the tray comprises a plurality of bubbling means including at the same time at least one valve and at least one slot. Advantageously, the slots can have a suitable shape and/or dimensions for directly forming bubbles to minimize the pressure drop and to limit weeping (liquid flowing into the casing). The slots can have various shapes which are rectangular, circular, elliptic, triangular, etc. In order to increase bubble formation, the slots can be covered by a cap positioned above the slot and raised in relation to the casing. The cap can prevent the liquid from entering the casing.

The gas passage casing allows a column to operate in counter-current mode, in which passage of the gas occurs from the underside to the top side of the tray.

Advantageously, the gas passage casing has a substantially parallelepipedic shape, to provide a wide opening for passage of the gas and thus to limit pressure drops. Furthermore, when the distributor tray comprises gas passage casing, which can be arranged parallel to one another. The gas passage casings are equipped with a bubbling system.

Unlike the case where the means for bubbling would be positioned at the same level as the tray, the casings projecting therefrom (and therefore from the means for bubbling) do not to perturb the liquid distribution and flow, which promotes uniform liquid distribution.

The casings are suited to be immersed, so that their height is smaller than the liquid guard height provided on the upper surface of the tray. Thus, the gas in bubble form is injected into the liquid.

The liquid passage means allows passage of the liquid from the top to the underside of the tray. According to an embodiment of the invention, the means for passing the liquid through the tray are a set of chimneys that can project from the upper side of the tray and/or the lower side of the tray. The chimneys can be substantially cylindrical. According to another embodiment of the invention, the means for passing the liquid through the tray are a series of orifices provided in the tray. According to another embodiment of the invention, the means allowing passage of the liquid through the tray comprise both chimneys and orifices. These liquid passage means are arranged between the gas passage casings. The number of liquid passage means is advantageously greater than the number of gas passage casings. The pitch of the liquid passage means can be triangular or square. In order to provide good supply and good distribution of the liquid on the contactor (packing), the liquid passage means are evenly distributed over the tray, to be arranged over the entire surface of the tray, between the casings.

Under standard operating conditions, the liquid passage means allow sufficient liquid flow rate ensuring a liquid guard on the upper tray at the level of the casings.

FIG. 4 illustrates a first embodiment of a distributor/exchanger tray according to the invention. FIG. 4 is a cross-sectional view of a portion of the distributor/exchanger tray.

The first embodiment of the invention relates to a distributor/exchanger tray 2 for a column providing material and/or heat exchange between a gas and a liquid, which comprises at least one casing 4 providing passage of the gas through the tray, at least one gas bubbling means and at least one liquid distribution system 14. According to the non-limitative example of FIG. 4, the means for bubbling gas can be a valve 15 allowing an emulsion zone LG to be created in the liquid guard, and thus allowing exchanges between the fluids on the upper part of the tray. However, the means for bubbling can be other means, such as those described above. Distributor tray 2 provides for formation of a liquid guard to be formed on the lower zone thereof, of height L1.

According to the non-limitative example of FIG. 4, the liquid passage means is a chimney 14 projecting from the lower part of the tray. However, the liquid passage means can be other means, notably orifices provided in tray 2.

For this embodiment, casing 4 and bubbling system 5 project from the upper part of tray 2 (oriented towards the top of the column), whereas liquid distribution system 14 projects from the lower part of tray 2 (oriented towards the bottom of the column).

Casing 4 and bubbling means 15 which provides a column operating in counter-current mode, in which passage of the gas occurs from the underside to the top side of the tray. Advantageously, gas passage casing 4 has a substantially parallelepipedic shape on which gas bubbling means 15 are positioned.

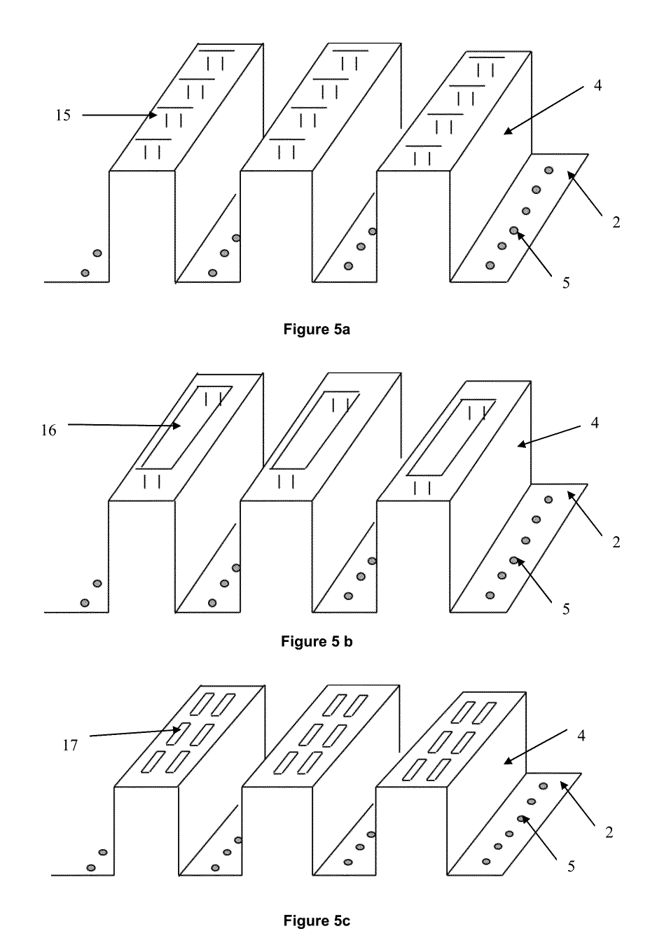

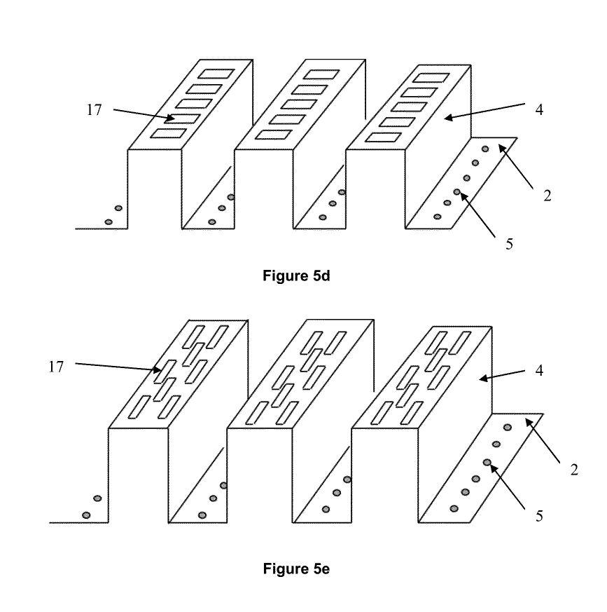

FIGS. 5a to 5e show, by way of non-limitative and non-exhaustive example, five variant embodiments of a distributor/exchanger tray according to the invention. FIGS. 5a to 5e are cross-sectional views of a portion of a distributor/exchanger tray.

For these variant embodiments, the means for passing liquid are orifices 5 provided in tray 2. However, these embodiments can be combined with other embodiments of the means for passing liquid, for example those described above which are the means for passing liquid which can notably can be chimneys.

As illustrated, casings 4 have a substantially parallelepipedic shape. However, these variant embodiments can also be suited to other casing shapes which may be cylindrical, cubic, hexahedral, etc.

According to the variant embodiment of FIG. 5a, the gas bubbling means have a series of cylindrical valves 15 arranged on each casing. Preferably, valves 15 can be evenly distributed over the casing. Alternatively, the valves can have other shapes, such as notably rectangular. Furthermore, each casing can comprise a single valve 15.

According to the variant embodiment of FIG. 5b, the means for bubbling gas a parallelepipedic slot having substantially the length of a gas passage casing. As illustrated, the slot can be covered by a cap 16 that is raised with respect to the casing. Cap 16 contributes to the formation of gas bubbles.

According to the variant embodiments of FIGS. 5c, 5d and 5e, the means for bubbling gas are a plurality of rectangular slots 17. For the variant embodiment of FIG. 5c, slots 17 are arranged along the principal direction (longitudinal direction) of casing 4. As illustrated by way of non-limitative example, each casing 4 can comprise a plurality of series of several slots 17. For the variant embodiment of FIG. 5d, slots 17 are arranged perpendicular to the principal direction (longitudinal direction) of casing 4. Each casing 4 can comprise a plurality of series of several slots 17. In the embodiment of FIG. 5e, slots 17 are arranged in several series in staggered rows. Slots 17 are arranged in the principal direction of casing 4.

These examples are not exhaustive and other implementations can be considered for the gas bubbling means.

The invention also relates to a column for material and/or heat exchange between two fluids, wherein two fluids are contacted by means of at least one gas/liquid contactor. The column comprises at least a first inlet for a liquid fluid, at least a second inlet for a gaseous fluid, at least a first outlet for a gaseous fluid and at least a second outlet for a liquid fluid. The column also comprises at least one distributor/exchanger tray as described above, providing distribution of the fluids over the contactor.

Preferably, the column comprises several sections containing a contactor which is a distributor tray as described above which is in each section.

The useful height of each tray also contributes to the heat and/or material exchange, in addition to the exchanges that occur in the contactor. The exchange column comprises no “loss of height” regarding the column efficiency. A column containing such a distributor tray can thus be less high, which involves reduced space requirement and column cost decrease.

Advantageously, the gas/liquid contactor is a structured packed bed. Alternatively, the gas/liquid contactor is a random packed bed.

Preferably, the gas and the liquid flow in the column operate in counter-current mode.

The column according to the invention can be used in gas treatment, CO₂ capture (using amine wash for example), distillation, dehydration or air conversion processes. Furthermore, the invention can be used with any type of solvent.

### Example

To illustrate the advantages of the present invention, the results obtained with an absorption column equipped with the present invention and those obtained with a column according to the prior art are compared. It is a case of deacidizing the acid compound CO₂ of a natural gas in order to reach a 2% target specification (spec) at the absorber outlet. The method uses a 40 wt. % amine solvent of Methydiethanolamine (MDEA) type, in a reactive absorption column equipped with a structured packing and a distributor/collector tray for the gas (natural gas) and liquid (solvent) phases. The properties of the absorption columns according to the invention and according to the prior art are described hereafter:

Properties of the Column According to the Prior Art
Number of collector/distributor trays according to the prior art: 5
Height of the collector/distributor trays: 1 m
Number of structured packing beds: 4
Effective surface area of the packing: 250 m²/m³
Height per bed: 8 m
Solvent flow rate: QL=46 m³/m²/h
Gas flow rate: Fs=2 (m/s) (kg/m³)^{0.5}
Pressure: 40 bar
Temperature: 40° C.
CO₂ concentration of the feed at the inlet: 8%.

Properties of the Column According to the Invention
Number of collector/distributor/exchanger trays according to the prior art: 5
Height of the collector/distributor trays: 1 m
Number of structured packing beds: 4
Effective surface area of the packing: 250 m²/m³
Height per bed: 8 m
Solvent flow rate: QL=46 m³/m²/h
Gas flow rate: Fs=2 (m/s) (kg/m³)^{0.5}
Pressure: 40 bar
Temperature: 40° C.
CO₂ concentration of the feed at the inlet: 8%.

The performances obtained are given in Table 1, which shows the evolution of the CO₂ concentration in the feed at different stages of the column. A stage corresponds to a column height integrating a packing bed and a distributor tray. The results show that the use of collector/distributor/exchanger trays according to the invention enables better transfer efficiency in the absorption column. Indeed, with the present invention, the specification is met at a lesser height in relation to a conventional column. The absorption column equipped with collector/distributor/exchanger trays thus provides a significant column height gain, of about 6 m, which is a decrease of about 15% in the total height of the absorber.

TABLE 1
Performances

| Column height | Inlet | Stage 1 | Stage 2 | Stage 3 | Stage 4 |
|---|---|---|---|---|---|
| CO₂ % (prior art) | 8.0 | 4.4 | 3.3 | 2.6 | 2.0 |
| CO₂ % (according to the | 8.0 | 3.7 | 2.9 | 2.2 | 1.6 |
| invention) | | | | | |

1-14. (canceled)

15. A distributor tray for a column provides heat and/or material exchange between a gas and a liquid, comprising:
at least one casing projecting from an upper part of the tray to provide for passage of the gas through the tray and at least one means for passing the liquid through the tray, wherein the at least one casing comprises at least one means for bubbling the gas.

16. A tray as claimed in claim 15, wherein the casing is parallelepipedic.

17. A tray as claimed in claim 16, wherein the means for bubbling comprises at least one valve and/or one slot of the casing.

18. A tray as claimed in claim 17, wherein the at least one slot is rectangular in shape.

19. A tray as claimed in claim 17, wherein a longitudinal direction of the at least one slot is perpendicular to a longitudinal direction of the casing.

20. A tray as claimed in claim 19, wherein the longitudinal direction of the slot is parallel to the longitudinal direction of the casing.

21. A tray as claimed in any one of claim 17, wherein the slot is covered by a cap.

22. A tray as claimed in claim 17, wherein the valve is rectangular.

23. A tray as claimed in claim 3, wherein the valve is cylindrical.

24. A tray as claimed in claim 15, wherein the means for passing the liquid comprises orifices and/or chimneys.

25. A tray as claimed in claim 24, wherein the chimneys project from the upper part of the tray and/or from a lower part of the tray.

26. A tray as claimed in claim 15, wherein the tray comprises means for passing liquid which are evenly distributed over the tray.

27. A column for heat and/or material exchange between a gas and a liquid, in accordance with claim 15 wherein the two fluids are contacted by packing and the column comprises at least one distributor tray for distributing the fluids over the packing.

28. A column as claimed in claim 27 providing a gas treatment, CO₂ capture, distillation, dehydration or an air conversion process.
